(19) United States
(12) Patent Application Publication
(10) Pub. No.: US 2005/0016311 A1
(43) Pub. Date: Jan. 27, 2005

(54) Device for operating a namual transmission

(75) Inventors: Ralph-Maria Netzker, Ludwigsburg (DE); Thomas Casper, Theley (DE); Daniel Bencina, Gruenkraut (DE); Gebhard Ruf, Schoeneburg (DE); Tibor Seibel, Weingarten (DE)

Correspondence Address: CROWELL & MORING LLP;INTELLECTUAL PROPERTY GROUP, P.O. BOX 14300, WASHINGTON, DC, 20044-4300, US

(73) Assignee: DR. ING. H.C.F. PORSCHE AG, Stuttgart (DE)

(21) Appl. No.: 10/854,791

(22) Filed: May 27, 2004

(30) Foreign Application Priority Data
May 28, 2003 (DE) 103 24 224.4

(51) Int. Cl. F16H 59/00

(52) U.S. Cl. 74/473.29

(57) ABSTRACT

A device for operating a manual transmission includes a shift lever, which includes inner and outer clutch halves arranged coaxially with one another. The inner clutch half is connectable to a shifter shaft, and a resilient element disposed between the clutch halves. The resilient element functions as an elastomechanical low-pass filter.

This application claims the priority of German Patent Document No. 103 24 224.4, filed May 28, 2003, the disclosure of which is expressly incorporated by reference herein.

### BACKGROUND AND SUMMARY OF THE INVENTION

The invention is directed to a device for operating a manual transmission.

To improve the shifting quality of a transmission, a shift lever connected to a shifter shaft is disclosed, for example, in DE 101 61 699 C1. The shift lever has an inner part configured as a resilient tongue to which the pull cable or gearshift mechanism of the transmission is articulated or fastened. When a shift is made, the inner part spaced away from the outer lever is resiliently deflected until it comes into contact with the outer lever in order to transfer the power flow to the shifter shaft. Thus a kind of elastomechanical low-pass filter is formed which filters out high-frequency shift disturbances before they become uncomfortably felt in the driver's hand. A disadvantage in this embodiment is, however, the relatively expensive process of manufacturing a resilient shift lever of this kind. Furthermore, on account of the relatively great flexural tensions, the material costs of such a shift lever are not inconsiderable.

German Patent 1067 644 furthermore discloses a resilient clutch wherein two clutch halves, guided coaxially with one another, each with cogs running radially outward and inward with the interposition of rubber rolls, feed the flow of power from the outer clutch halves through the rubber rolls and the inner clutch halves accordingly.

It is therefore an object of the invention to develop a shift lever for the actuating device of a manual transmission, which is able to avoid or reduce high-frequency shift disturbances and can be manufactured at reasonable cost, for example by the use of standard components.

The shift lever of the invention is distinguished by simple design, while the shift lever including a plurality of single components can also be assembled by automation. On account of the resilient elements provided between the two clutch halves, high-frequency shift disturbances manifesting themselves in the form of oscillation, vibration or grinding when they synchronize are effectively eliminated.

The inner clutch half to be attached to the shifter shaft is in the form of a driver ring with cogs reaching radially outward, which is situated in an opening in the outer clutch half. The outer clutch half is provided with cogs reaching radially inward, while a resilient clutch body or parts thereof are situated between the cogs of the inner and outer clutch half.

The resilient coupling body is advantageously formed in a first embodiment by rubber bodies including individual cylindrical rollers. Studies have shown that, when various gear-shifting forces are applied, a highly progressive spring characteristic has an especially positive effect on the desired damping. In this connection, therefore, the resilient clutch bodies acting as spring elements with curved abutment or contact surfaces are especially suited for imitating such a characteristic, since as the resilient clutch bodies increasingly deform, the area of contact with the rubber bodies increases.

In a second advantageous embodiment the resiliently configured coupling body includes a plate-like driver element which, like the cylindrical rollers, has curved or radiused contact surfaces for the cogs of the driver, so that in this case too, a progressive spring characteristic can be realized. The plate-like driver can be installed in the outer clutch half by the injection molding process, for example, or can be set as a separate component between the inner and outer clutch halves.

To avoid overloading or premature wear-out of the resilient coupling body, recesses are provided in the outer clutch half, whose lateral boundaries serve as an abutment for the cogs of the driver (inner clutch half), i.e., after contact surfaces of the resilient coupling body cooperating with the cogs of the coupling body have been deformed by great working stresses, beyond this depth of deformation the force or operating torque is transferred directly from the outer clutch half to the inner driver. In addition, the cushioning achieved by the resilient elements can thus also be discontinued in the case of hard and rapid engagements. This does not have any perceptible disadvantage as regards shifting comfort, since the shift disturbances become undesirably apparent only in the case of normal and slow shifting operations.

Other objects, advantages and novel features of the present invention will become apparent from the following detailed description of the invention when considered in conjunction with the accompanying drawings.

### BRIEF DESCRIPTION OF THE DRAWINGS

FIG. 1 is an exploded view of the shift lever of the invention in a first embodiment.

FIG. 2 is a cross section taken through the assembled shift lever.

FIG. 3 is an exploded view of the shift lever of the invention in a second embodiment.

FIG. 4 is a cross section taken through the assembled shift lever according to the second embodiment.

FIG. 5 is a diagram representing a spring characteristic.

### DETAILED DESCRIPTION OF THE DRAWINGS

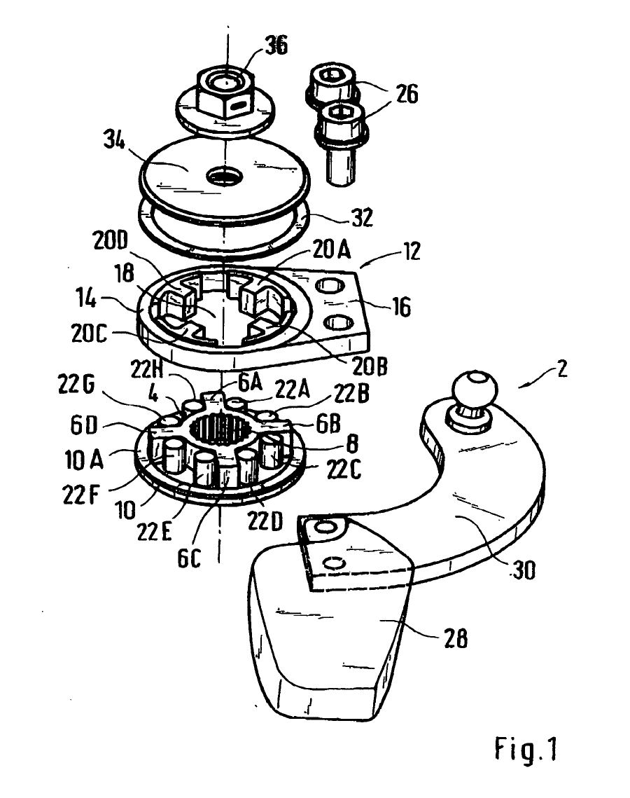

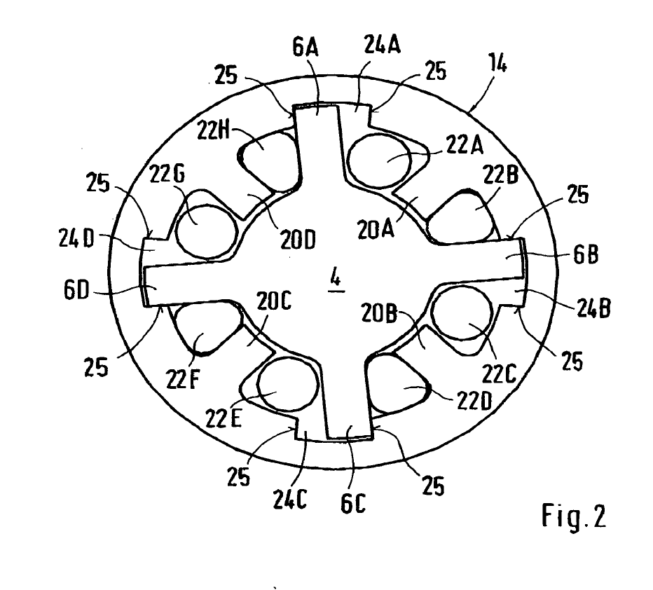

The shift lever shown in detail in FIG. 1 has an inner clutch half for fastening to a shifter shaft not shown; it will be identified hereinafter as a driver cross 4 and is provided in the present embodiment with four cogs 6a to 6d extending radially outward. The driver cross 4 has a central, internally toothed opening 8 which is engaged by external teeth of the shifter shaft. The driver cross 4 is also integral with a circular supporting plate 10. The shift lever 2 has an outer clutch half 12 which is a component of flat shape with a clutch ring 14 and a mounting projection 16. The clutch ring 14 has an opening 18 in which the driver cross 4 is received in the assembled state, and then the ring surface 10 comes in contact laterally with its ring surface 10a against the supporting plate 10. The clutch ring 14 has cogs 20a to 20d pointing radially into the opening 18, which in the assembled state meshes tooth-like with the cogs 6a to 6d of the driver cross 4. As seen especially in FIG. 2, clutch bodies in the form of cylindrical rolls 22a to 22h are held between the cogs 6a to 6d of the driver cross 4 and the cogs 20a to 20d. The cylindrical rolls 22 are configured as resilient bodies which is made from, for example, natural rubber or synthetic rubber. As it is furthermore shown in FIG. 2, the cogs 6a to 6d of the driver cross 4 engage at their radial outer ends in recesses 24a to 24d provided on the outer circumference of the clutch ring 14. Thus their left and right lateral limits 25 serve as abutment surfaces for cogs 6a to 6d, so that in shift operations the deformation of the cylindrical rolls 22 which they entail is limited. The cogs of the inner and outer clutch halves 6 and 12, and the rubber bodies held in the interstices are so dimensioned that, in the neutral state, a fit results which is substantially without free play.

Also in FIG. 1 can be seen two fastening screws 26 with which the outer clutch half 12 is fastened to the actual lever 30 of the shift lever 2 with the interposition of a weight 28, the weight 28 cooperating together with the cylindrical rolls 22a to 22h as a weight-and-spring system. Moreover, a spacer ring 32 as well as a disk 34 are provided by which the clutch ring 14 and the outer clutch half 12 is closed off on the side opposite the support plate 10. A nut 36 serves for fastening the shift lever 2 to the shifter shaft, not shown.

If a force is applied through the shift articulation or the pull cable of the transmission to the arm 30 of the shift lever 2, it is transmitted via the cylindrical rolls 22a to 22h to the driver cross 4 and thus the shifter shaft is operated. Depending on how great the force applied by the driver is, the cylindrical rolls are deformed accordingly. As shown in FIG. 5, due to the curved or radiused contact surface of the rolls 22a to 22h, a very progressive spring characteristic results which is especially able to suppress shift disturbances produced by the shifting and synchronization process. In order to limit deformation of the cylindrical rolls 22a to 22h, the cogs 61 to 6d of the driver cross 4 strike, in the case of great shifting force, against the surfaces 25 of the recesses 24 provided in the clutch ring 14.

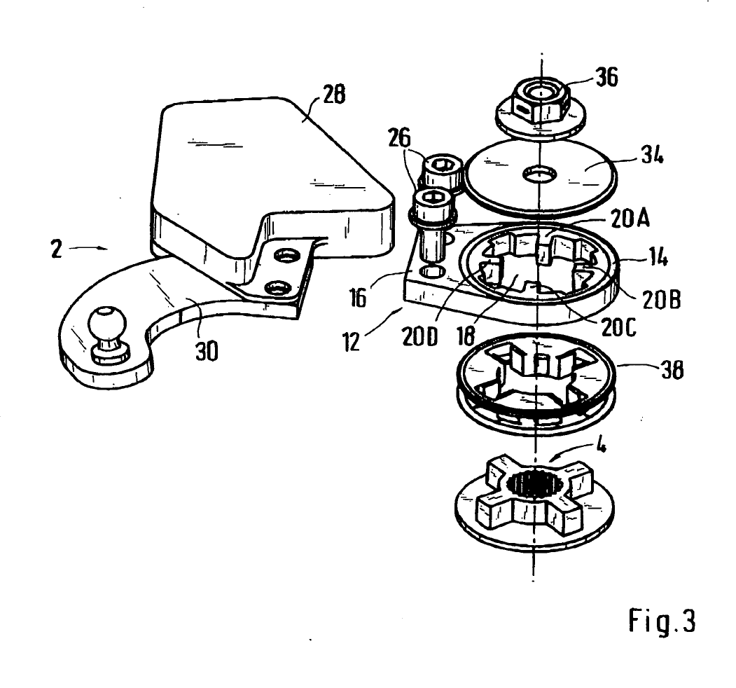

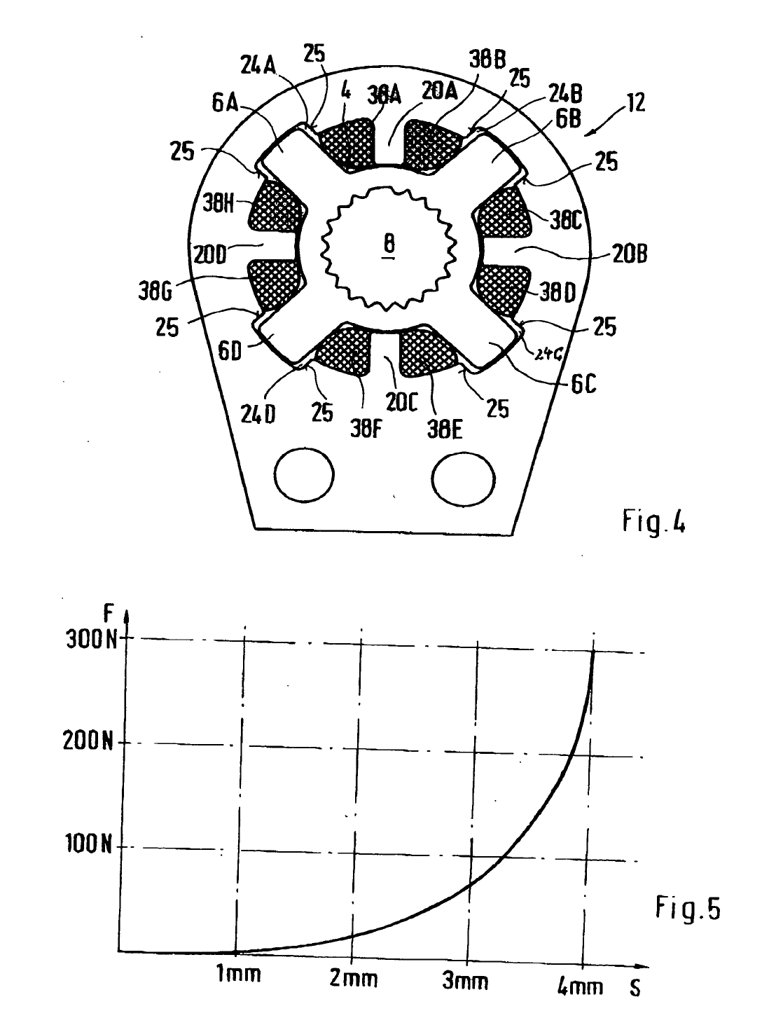

In a second embodiment (see FIGS. 3 and 4), in which equal components are provided with equal reference numbers, a disk-like driver means 38 is provided as a resilient clutch body between driver cross 4 and outer clutch half 12, which, like the cylindrical rolls 22, serves together with the weight element 28 to filter out high-frequency shift disturbances. The cogs 6a to 6d of the driver cross 4 are in this case limited by the individual segments 38a to 38h of the disk-shaped driver means 38, while the surfaces for abutment by the cogs 6a to 6d of segments 38a to 38h are made curvilinear or provided with a radius. Thus, like the first embodiment, the highly progressive spring characteristic shown in FIG. 5 can be achieved, by means of which high-frequency shift disturbances can be effectively reduced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A device for operating a manual transmission, comprising:
a shift lever including
inner and outer clutch halves arranged coaxially with one another, wherein the inner clutch half is connectable to a shifter shaft, and
a resilient element disposed between the clutch halves, wherein the resilient element functions as an elastomechanical low-pass filter.

2. The device according to claim 1, further comprising a plurality of resilient elements, wherein the inner clutch half includes a drive cross having cogs extending radially outward from the drive cross, wherein the outer clutch half includes an opening and cogs extending radially inward, wherein the drive cross is accommodated in the opening of the outer clutch half, and wherein one resilient element is disposed between each cog of the inner clutch half and an adjacent cog of the outer clutch half.

3. The device according to claim 2, wherein the resilient elements are configured as rubber bodies of cylindrical shape.

4. The device according to claim 1, wherein the resilient element is configured as a disk including segments, wherein the inner clutch half includes a drive cross having cogs extending radially outward from the drive cross, wherein the outer clutch half includes an opening and cogs extending radially inward, wherein the drive cross is accommodated in the opening of the outer clutch half, and wherein one segment of the resilient element is disposed between each cog of the inner clutch half and an adjacent cog of the outer clutch half.

5. The device according to claim 4, wherein the outer clutch half includes recesses, and free ends of the cogs of the inner clutch half are disposed in the recesses of the outer clutch half, respectively, and wherein lateral boundaries of the recesses serve as abutments for the cogs of the inner clutch half allowing a direct driving of the outer clutch half by the inner clutch half.

6. The device according to claim 5, wherein upon the end abutment of the cogs, the segment disposed between each two cogs is at least partially deformed.

7. The device according to claim 3, wherein the outer clutch half includes recesses, and free ends of the cogs of the inner clutch half are disposed in the recesses of the outer clutch half, respectively, and wherein lateral boundaries of the recesses serve as abutments for the cogs of the inner clutch half allowing a direct driving of the outer clutch half by the inner clutch half.

8. The device according to claim 7, wherein upon the end abutment of the cogs of the inner clutch half, the resilient element disposed between each two cogs is at least partially deformed.

9. The device according to claim 2, wherein the outer clutch half includes recesses, and free ends of the cogs of the inner clutch half are disposed in the recesses of the outer clutch half, respectively, and wherein lateral boundaries of the recesses serve as abutments for the cogs of the inner clutch half allowing a direct driving of the outer clutch half by the inner clutch half.

10. The device according to claim 9, wherein upon the end abutment of the cogs, the resilient elements disposed between each two cogs is at least partially deformed.

11. The device according to claim 1, wherein the shift lever has a weight element.

12. A method for making device for operating a manual transmission, comprising the steps of:
arranging inner and outer clutch halves of a shift lever coaxially with one another, wherein the inner clutch half is connectable to a shifter shaft, and
disposing a resilient element between the clutch halves, wherein the resilient element functions as an elastomechanical low-pass filter.
